(19) United States
(12) Patent Application Publication
(10) Pub. No.: US 2014/0107007 A1
(43) Pub. Date: Apr. 17, 2014

(54) INK JET CLEANING SOLUTION

(71) Applicant: Seiko Epson Corporation, Tokyo (JP)

(72) Inventors: Akihito Sao, Matsumoto-shi (JP); Makoto Nagase, Shiojiri-shi (JP); Kenichiro Kubota, Matsumoto-shi (JP)

(73) Assignee: SEIKO EPSON CORPORATION, Tokyo (JP)

(21) Appl. No.: 14/053,777

(22) Filed: Oct. 15, 2013

(30) Foreign Application Priority Data
Oct. 16, 2012 (JP) 2012-228638

(51) Int. Cl. B41J 2/165

(52) U.S. Cl. CPC B41J 2/16552
USPC 510/170

(57) ABSTRACT

An ink jet cleaning solution is provided for washing off a non-aqueous ink and an aqueous ink. The cleaning solution contains an organic solvent and water. The organic solvent has an SP value between the weighted average S1 of the SP values of the organic solvents in the non-aqueous ink and the weighted average S2 of the SP values of the organic solvents in the aqueous ink. Also, the weighted average of the SP values of the organic solvent and the water in the cleaning solution is in the range between S1 and S2.

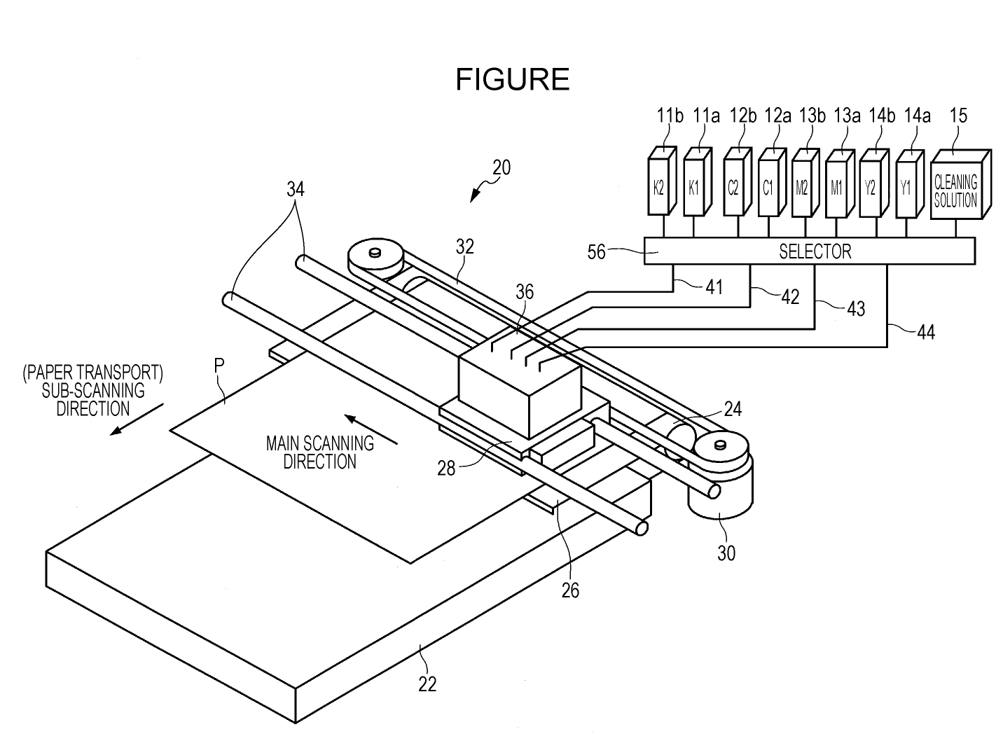

### BACKGROUND

1. Technical Field

The present invention relates to an ink jet cleaning solution.

2. Related Art

So-called ink jet recording apparatuses have been known, which records information in the form of images and characters with very small ink droplets ejected through nozzles of an ink jet recording head. An ink used for recording such information with an ink jet recording apparatus is typically an aqueous ink prepared by dissolving or dispersing a coloring material, such as pigment, in a mixture of an organic solvent and water, or a non-aqueous ink prepared by dissolving or dispersing a coloring material in an organic solvent.

These aqueous and non-aqueous inks may be selectively used depending on the recording medium on which images will be recorded. For example, aqueous inks are often used for recording information on an ink-absorbent recording medium, such as plain paper or special paper. On the other hand, non-aqueous inks are used for recording on an ink-low absorbent or ink-non-absorbent recording medium, such as a plastic film.

If a thickened portion of an ink or aggregate is present in a flow channel of the ink jet recording apparatus through which the ink flows, ink ejection failure may occur. Accordingly, for example, JP-A-10-337882, JP-A-2011-126147, JP-A-2010-260296, JP-A-2009-155424 and JP-A-2004-115553 disclose techniques for eliminating clogging of flow channels with an ink by passing a cleaning solution or the like containing an organic solvent through the ink channels.

In these techniques, the ink flow channels are filled with the cleaning solution after being cleaned with the cleaning solution. Accordingly, from the viewpoint of facilitating the replacement of the cleaning solution with the ink, or preventing the ink from failing to disperse or from deteriorating in a property, the same solvent may be used in the cleaning solution and the ink, or the cleaning solution and the ink may have similar compositions.

However, the compositions of inks generally used in ink jet recording apparatuses are considerably different between the non-aqueous ink and the aqueous ink. Accordingly, in order to wash off these inks, different cleaning solutions having different compositions are required. In particular, when an aqueous ink and a non-aqueous ink are used in the same ink jet recording apparatus, inconvenience or problems may occur. For example, it may take time to switch the cleaning solutions, or an incorrect cleaning solution may be selected.

### SUMMARY

An advantage of some aspects of the invention is that it provides an ink jet cleaning solution that is suitable to wash off both non-aqueous inks and aqueous inks. The following embodiments of the invention solve at least part of the above-described issues.

### Application 1

According to an aspect of the invention, an ink jet cleaning solution is provided for washing off a non-aqueous ink and an aqueous ink. The cleaning solution contains an organic solvent and water. The organic solvent has an SP value between the weighted average SP value S1 of the organic solvent in the non-aqueous ink and the weighted average SP value S2 of the organic solvent in the aqueous ink. Also, the weighted average of the SP values of the organic solvent and the water in the cleaning solution is in the range between S1 and S2.

The cleaning solution can satisfactorily wash off both the non-aqueous ink and the aqueous ink.

### Application 2

The organic solvents in the cleaning solution, the non-aqueous ink and the aqueous ink may each contain a water-soluble organic solvent.

### Application 3

The organic solvent in the cleaning solution may have a hydroxy group.

### Application 4

Preferably, the difference between the weighted average SP values S1 and S2 is 5 or less.

### Application 5

The range between the weighted average SP values S1 and S2 may be from 10.0 to 15.0.

### Application 6

The range between the weighted average SP values S1 and S2 may be from 11.5 to 13.0.

### Application 7

The cleaning solution may be used in an ink jet recording apparatus using both the non-aqueous ink and the aqueous ink.

### Application 8

The organic solvent in the cleaning solution may contain at least one compound selected from the group consisting of polyhydric alcohols and glycol ethers.

### BRIEF DESCRIPTION OF THE DRAWINGS

The invention will be described with reference to the accompanying drawing, wherein like numbers reference like elements.

The FIGURE is a schematic perspective view illustrating major parts of a printer including a selector.

### DESCRIPTION OF EXEMPLARY EMBODIMENTS

Preferred embodiments of the invention will now be described. The following embodiments will be described by way of example. The invention is not limited to the disclosed embodiments, and various modifications may be made within the scope and spirit of the invention.

### 1. CLEANING SOLUTION

The ink jet cleaning solution of an embodiment of the invention is used for washing off a non-aqueous ink and an aqueous ink. The cleaning solution contains an organic solvent and water. The organic solvent has an SP value between the weighted average S1 of the SP values of the organic solvents in the non-aqueous ink and the weighted average S2 of the SP values of the organic solvents in the aqueous ink. Also, the weighted average of the SP values of the organic solvent and water in the cleaning solution is in the range between S1 and S2.

The term SP value mentioned herein refers to a solubility parameter. An SP value can be calculated using latent heat of vaporization, vapor pressure, surface tension, critical pressure, thermal expansion coefficient or molecular attraction constant, or by a dissolving method or a swelling method. In the following description, an SP value is a value calculated using Small's molecule binding constants shown in Table 13-2 on page 275 of Temple C. Patton, “Paint Flow and Pigment Dispersion” (Japanese-translated edition, Kyoritsu shuppan Co., Ltd.)

The term “weighted average of the SP values of organic solvents” or weighted average SP value of organic solvents” mentioned herein refers to a weighted average calculated by weighting the SP values of the solvents contained in an ink with the contents of the solvents in the ink. For Example, the weighted average SP value (A1) of ink A containing X g of organic solvent A having an SP value of δ_{A} and Y g of organic solvent B having an SP value of δ_{B} is calculated using the following equation (1):

A1={(δ_{A}×X)+(δ_{B}×Y)}/(X+Y) (1)

For an ink containing only one organic solvent, the weighted average SP value of the organic solvent equal to the SP value of the organic solvent.

The term “weighted average of the SP values of the organic solvent and water” mentioned herein refers to a weighted average calculated by weighting the SP value of each organic solvent and water contained in a cleaning solution with their contents in the cleaning solution. For example, the weighted average (A2) of the organic solvent and water in cleaning solution A containing X g of organic solvent A having an SP value of δ_{A}, Y g of organic solvent B having an SP value of δ_{B}, and Z g of water having an SP value of δ_{c} is calculated using the following equation (2):

A2={(δ_{A}×X)+(δ_{B}×Y)+(δ_{C}×Z)}/(X+Y+Z) (2)

The present inventors found that when both the SP value of the organic solvent in the cleaning solution and the weighted average of the SP values of the organic solvent and water in the cleaning solution are in the range between S1 and S2, the cleaning power of the cleaning solution is significantly increased against both the non-aqueous ink and the aqueous ink, but the reason is not clear. Thus, when a non-aqueous ink and an aqueous ink are used, these two types of ink can be washed off with the cleaning solution of the present embodiment without requiring different cleaning solutions that are generally required to wash off different types of ink.

The constituents in the cleaning solution of an embodiment will now be described in detail.

### 1.1. Organic Solvent

The cleaning solution contains at least one organic solvent. The organic solvent in the cleaning solution has an SP value in the range between the weighted average SP value S1 of the organic solvents contained in a non-aqueous ink described later and the weighted average SP value S2 of the organic solvents contained in an aqueous ink described later.

By setting the SP value of the organic solvent contained in the cleaning solution in the range between S1 and S2, the cleaning power of the cleaning solution is increased against both the non-aqueous ink and the aqueous ink to the extent of easily washing off both inks. Thus, the amount of the cleaning solution to be used and the cleaning time can be reduced. On the other hand, if the SP value of the organic solvent contained in the cleaning solution is outside the above range, the cleaning power against at least either the non-aqueous ink or the aqueous ink may decrease, or the cleaning solution may not sufficiently disperse at least either the non-aqueous ink or the aqueous ink. This may be a cause of contamination with foreign matter.

The cleaning solution may contain only one organic solvent or two or more organic solutions. If the cleaning solution contains two or more organic solvents, each of the organic solvents has an SP value in the range between S1 and S2.

Each of the organic solvents used in the cleaning solution can be a compound having an SP value in the range between S1 and S2 selected from among glycol ethers, polyhydric alcohols, lactones, pyrrolidone derivatives, organosulfur compounds, alcohols, ketones, esters, and ethers.

Glycol ethers include alkylene glycol monoethers and alkylene glycol diethers.

Examples of alkylene glycol monoethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol monohexyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of alkylene glycol diethers include ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, tetraethylene glycol butyl methyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of polyhydric alcohols include glycerol, 1,2,6-hexanetriol, trimethylolpropane, pentamethylene glycol, trimethylene glycol, ethylene glycol, propylene glycol, diethylene glycol, triethylene glycol, tetraethylene glycol, pentaethylene glycol, polyethylene glycol having a number average molecular weight of 2000 or less, dipropylene glycol, tripropylene glycol, isobutylene glycol, 2-butene-1,4-diol, 2-ethyl-1,3-hexanediol, 2-methyl-2,4-pentanediol, meso erythritol, pentaerythritol, 1,2-pentanediol, 1,2-hexanediol, 1,3-propanediol, 1,4-butanediol, 1,5-pentanediol, 1,6-hexanediol, 1,7-heptanediol, and 1,8-octanediol.

Examples of lactones include β-propiolactone, β-butyrolactone, γ-butyrolactone, γ-valerolactone, and γ-caprolactone.

Examples of pyrrolidone derivatives include N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone.

Examples of organosulfur compounds include dimethyl sulfoxide, dimethylsulfone, and sulfolane.

Examples of alcohols include methyl alcohol, ethyl alcohol, propyl alcohol, butyl alcohol, and fluoroalcohols. Examples of ketones include acetone, methyl ethyl ketone, and cyclohexanone. Examples of esters include ethyl lactate, isopropyl lactate, butyl lactate, methyl acetate, ethyl acetate, propyl acetate, butyl acetate, methyl propionate, and ethyl propionate. Examples of ethers include diethyl ether, dipropyl ether, tetrahydrofuran, and dioxane.

Preferably, the organic solvent contained in the cleaning solution contains at least one compound selected from among the polyhydric alcohols and glycol ethers. Polyhydric alcohols and glycol ethers are often used as solvents of ordinary ink jet inks (non-aqueous inks and aqueous inks). Therefore, a cleaning solution containing any of these organic solvents can have a composition similar to the compositions of the ink jet inks. Thus, inks can be dispersed to prevent contamination with foreign matter, and it may become easy to wash off inks.

The cleaning solution preferably contains a water-soluble organic solvent. The water-soluble organic solvent enhances the compatibility of the cleaning solution with aqueous inks, thus making it easy to wash off aqueous inks.

In the description herein, a “water-soluble” solvent implies that when the solvent is slowly mixed with the same volume of pure water at a temperature of 20° C. under 1 atmospheric pressure, the mixture maintains a uniform appearance after the flow of the mixture has calmed down. Preferably, the water-soluble organic solvent has a solubility (mass of solute) of 10.0 g or more in 100 g of water at 20° C.

The organic solvent contained in the cleaning solution preferably has a hydroxy group in the molecular structure. The hydroxy group enhances the compatibility of the cleaning solution with aqueous inks, thus making it easy to wash off aqueous inks.

The organic solvent content in the cleaning solution is not particularly limited as long as the weighted average of the SP values of the organic solvent and water in the cleaning solution is in the range between S1 and S2. For example, the organic solvent content in the cleaning solution may be in the range of 10% to 90% by mass, such as 50% to 90% by mass or 60% to 90% by mass, relative to the total mass of the cleaning solution.

### 1.2. Water

The cleaning solution of the present embodiment contains water. Preferably, the water contained in the cleaning solution is pure water or ultrapure water from which ionic impurities have been removed as much as possible. Examples of such water include ion exchanged water, ultrafiltered water, reverse osmosis water, and distilled water. Preferably, sterile water prepared by, for example, UV irradiation or addition of hydrogen peroxide is used. The use of sterile water can prevent, for a long time, the occurrence of mold or bacteria in the cleaning solution.

The water content in the cleaning solution is not particularly limited as long as the weighted average of the SP values of the organic solvent and water in the cleaning solution is in the range between S1 and S2. For example, the water content in the cleaning solution may be in the range of 10% to 90% by mass, such as 10% to 50% by mass or 10% to 40% by mass, relative to the total mass of the cleaning solution.

### 1.3. Other Constituents

The cleaning solution may contain a surfactant, a coloring material, a preservative or fungicide, a pH adjuster, and other additives from the viewpoint of improving the cleaning power.

### Surfactant

The cleaning solution may contain a surfactant because the surfactant can enhance the wettability of the cleaning solution to ink flow channels and allows the cleaning solution to clean ink flow channels satisfactorily. Examples of such a surfactant include, but are not limited to, silicone surfactants, fluorochemical surfactants, and polyoxyethylene derivatives acting as nonionic surfactants.

### Coloring Material

A coloring material may be used so that the cleaning solution is visible. The coloring material may be a known dye or pigment.

### Preservative or Fungicide

Examples of the preservative or fungicide include sodium benzoate, sodium pentachlorophenol, sodium 2-pyridine thiol-1-oxide, sodium sorbate, sodium dehydroacetate, and 1,2-dibenzisothiazolin-3-one (Proxel CRL, Proxel BDN, Proxel GXL, Proxel XL-2, and Proxel TN, each produced by ICI).

### pH Adjuster

Examples of the pH adjuster include potassium dihydrogenphosphate, sodium dihydrogenphosphate, sodium hydroxide, lithium hydroxide, potassium hydroxide, ammonia, diethanolamine, triethanolamine, triisopropanolamine, potassium carbonate, sodium carbonate, and sodium hydrogencarbonate.

### 1.4. Properties of Cleaning Solution

In the cleaning solution of the present embodiment, the weighted average S3 of the SP values of the organic solvent and water is in the range between S1 and S2. By controlling the S3 value in the range between S1 and S2, the cleaning power of the cleaning solution is increased to the extent of easily washing off both the non-aqueous ink and the aqueous ink. Thus, the amount of the cleaning solution to be used and the cleaning time can be reduced. On the other hand, if the S3 value of the organic solvent is outside the above range, the cleaning power against at least either the non-aqueous ink or the aqueous ink may decrease, or the cleaning solution may not sufficiently disperse at least either the non-aqueous ink or the aqueous ink. This may be a cause of contamination with foreign matter.

Preferably, the cleaning solution has a viscosity in the range of 2 to 10 mPa·s, more preferably 3 to 6 mPa·s, at 20° C. so as to be easily discharged through nozzles of the head of an ink jet recording apparatus. The viscosity of the cleaning solution can be measured with a viscoelasticity meter MCR-300 (manufactured by Pysica) by increasing the shear rate to 10 to 1000 at 20° C. and reading the indication of the meter at a shear rate of 200.

### 1.5. Preparation of Cleaning Solution

The cleaning solution of the present embodiment can be prepared by mixing the above-described constituents in an arbitrary order and optionally removing impurities by, for example, filtration. It may be suitable for mixing that the constituents are added one after another into a container equipped with a stirrer, such as a mechanical stirrer or a magnetic stirrer, and mixed together. Filtration may be performed as required by, for example, centrifugal filtration or using a filter paper.

### 2. INKS

The cleaning solution of the present embodiment is used for washing off a non-aqueous ink and an aqueous ink. More specifically, the cleaning solution washes the flow channel in an ink jet recording apparatus through which inks flow, thereby removing the inks and foreign matter from the flow channel.

The non-aqueous ink and aqueous ink that the cleaning solution of the present embodiment will wash off will now be described in detail.

### 2.1. Non-Aqueous Ink

The term “non-aqueous ink” mentioned herein refers to an ink prepared without intentionally adding water, but may contain a trace amount of water unavoidably added during manufacture and storage.

### 2.1.1. Organic Solvent

The non-aqueous ink that the cleaning solution of the present embodiment will wash off contains an organic solvent. The organic solvent contained in the non-aqueous ink may be composed of a single solvent or may contain two or more solvents.

Preferably, the organic solvent in the non-aqueous ink contains a water-soluble organic solvent. The water-soluble organic solvent in the non-aqueous ink can enhance the compatibility of the non-aqueous ink with the cleaning solution containing water, thus making it easy to wash off the non-aqueous ink with the cleaning solution.

The compounds cited in the above-described section “1.1. Organic solvent” can be used as the organic solvent in the non-aqueous ink. Among those organic solvents, glycol ethers and lactones are suitable as the organic solvent contained in the non-aqueous ink from the viewpoint of fixing the ink to an ink-low-absorbent or ink-non-absorbent recording medium.

The organic solvent in the non-aqueous ink can occupy the portion of the ink other than the solid components including the coloring material, and the content of the organic solvent in the non-aqueous ink may be, but is not limited to, 50% to 99% by mass, preferably 60% to 95% by mass, relative to the total mass of the non-aqueous ink.

### 2.1.2 Other Constituents

### Coloring Material

The non-aqueous ink contains a coloring material. The coloring material may be a dye, an inorganic pigment or an organic pigment. These coloring materials may be used singly or in combination.

Exemplary organic pigments include azo pigments, such as azo lake, insoluble azo pigments, condensed azo pigments, and chelate azo pigments; polycyclic pigments, such as phthalocyanine pigments, perylene and perylene pigments, anthraquinone pigments, quinacridone pigments, dioxazine pigments, thioindigo pigments, isoindolinone pigments, and quinophthalone pigments; dye lakes, such as basic dye lakes and acid dye lakes; nitro pigments; nitroso pigments; aniline black; and daylight fluorescent pigments. Exemplary inorganic pigments include carbon black, titanium dioxide, silica, and alumina.

Exemplary magenta or red organic pigments include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 170, C. I. Pigment Red 177, C. I. Pigment Red 178, C. I. Pigment Red 194, C. I. Pigment Red 209, C. I. Pigment Red 222, and C. I. Pigment Red 224.

Exemplary orange or yellow organic pigments include C. I. Pigment Orange 31, C. I. Pigment Orange 43, C. I. Pigment Orange 64, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 150, and C. I. Pigment Yellow 180.

Exemplary green or cyan organic pigments include C. I. Pigment Blue 15, C. I. Pigment Blue 15:2, C. I. Pigment Blue 15:3, C. I. Pigment Blue 16, C. I. Pigment Blue 60, C. I. Pigment Green 7, and C. I. Pigment Green 36. An example of black inorganic pigments may be carbon black.

The pigment content can be set as needed without particular limitation, and is generally in the range of 0.1% to 10% by mass relative to the total mass of the non-aqueous ink.

### Dispersant

The non-aqueous ink may contain a dispersant from the viewpoint of stably dispersing the coloring material in the ink. Examples of the dispersant include polyester polymers such as Hinoact series: KF1-M, T-6000, T-7000, T-8000, T-8350P, and T-8000E (each produced by Kawaken Fine Chemicals); Solsperse series: 20000, 24000, 32000, 32500, 33500, 34000, 35200, and 37500 (each produced by LUBRIZOL); Disperbyk series: 161, 162, 163, 164, 166, 180, 190, 191, 192, 2091, and 2095 (each produced by BYK); FLOWLEN series: DOPA-17, DOPA-22, DOPA-33, and G-700 (each produced by Kyoeisha Chemical); AJISPER series: PB 821 and PB 711 (each produced by Ajinomoto Fine-Techno); and LP 4010, LP 4050, LP 4055, and EFKA POLYMER series 400, 401, 402, 403, 450, 451 and 453 (each produced by EFKA Chemicals).

### Binder Resin

The non-aqueous ink may contain a binder resin to control the viscosity thereof. Examples of the binder resin include acrylic resin, styrene acrylic resins, rosin-modified resins, phenol resins, terpene resins, polyester resins, polyamide resins, epoxy resins, urethane resins, vinyl chloride-vinyl acetate copolymer resins, cellulose acetate butyrate and other fiber resins, and vinyl toluene-α-methylstyrene copolymer resins. These binder resins may be used singly or in combination. The fixity of the non-aqueous ink to recording media can be further enhanced by varying the binder resin content in the ink.

### Surfactant

The non-aqueous ink may contain a surfactant to reduce the surface tension thereof and increase the wettability to recording media. Examples of the surfactant include silicone surfactants, fluorochemical surfactants, and polyoxyethylene derivatives acting as nonionic surfactants.

Preferred silicone surfactants include polyester-modified silicones and polyether-modified silicones. Examples of such a silicone surfactant include BYK-347, BYK-348, BYK-UV3500, BYK-UV3510, BYK-UV3530, and BYK-UV3570 (each produced by BYK).

An example of preferred fluorochemical surfactants may be a fluorine-modified polymer, such as BYK-340 (produced by BYK).

An example of preferred polyoxyethylene derivatives may be an acetylene glycol-based surfactant. More specifically, examples of such a surfactant include Surfynol series: 82, 104, 465, 485, and TG (each produced by Air Products); Olfine series: STG and E1010 (each produced by Nissin Chemistry Industry); NissanNonion series: A-10R and A-13R (each produced by NOF Corporation); FLOWLEN series: TG-740W and D-90 (produced by Kyoeisha Chemical); and NOIGEN CX-100 (produced by Dai-ichi Kogyo Seiyaku).

### Other Constituents

The non-aqueous ink may contain a preservative or fungicide, a pH adjuster, and other additives. These constituents can be selected from the materials cited in the above-described section “1.3. Other Constituents”.

### 2.2. Aqueous Ink

### 2.2.1. Organic Solvent

The aqueous ink that the cleaning solution of the present embodiment will wash off contains an organic solvent. The organic solvent contained in the aqueous ink may be composed of a single solvent or may contain two or more solvents.

Preferably, the organic solvent in the aqueous ink contains a water-soluble organic solvent. The water-soluble organic solvent in the aqueous ink can prevent separation of the constituents in the ink.

The compounds cited in the above-described section “1.1. Organic solvent” can be used as the organic solvent in the aqueous ink. Among those organic solvents, glycol ethers and polyhydric alcohols are suitable as the organic solvent in the aqueous ink, from the viewpoint of increasing the wettability of the ink to recording media and preventing the ink from drying.

The organic solvent content in the aqueous ink is preferably in the range of 10% to 50% by mass, more preferably 10% to 40% by mass, relative to the total mass of the aqueous ink.

### 2.2.2. Water

The aqueous ink contains water. The water is a major solvent of the aqueous ink and will be evaporated by being dried. Preferably, the water is pure water or ultrapure water from which ionic impurities have been removed as much as possible. Examples of such water include ion exchanged water, ultrafiltered water, reverse osmosis water, and distilled water. Preferably, sterile water prepared by, for example, UV irradiation or addition of hydrogen peroxide is used. The use of sterile water can prevent, for a long time, the occurrence of mold or bacteria in the pigment dispersion and the ink containing the pigment dispersion.

The weighted average SP value S2 of the aqueous ink does not take water or the major solvent into account. This is because water is easier to evaporate than organic solvents when the aqueous ink is allowed to stand. Since part of the water in the aqueous ink has been evaporated before the aqueous ink is washed off, the weighted average SP value of the solvents of the aqueous ink including water varies from the value immediately after preparation.

The water content in the aqueous ink is preferably in the range of 50% to 90% by mass, more preferably 60% to 90% by mass, relative to the total mass of the aqueous ink.

### 2.2.3 Other Constituents

The aqueous ink contains a coloring material. The coloring material may be an inorganic pigment or an organic pigment. Such pigments may be used singly or in combination. The pigment of the aqueous ink can be selected from the pigments cited in the above-described section “2.1.2. Other Constituents”.

The aqueous ink may contain a dispersant, a surfactant, a binder resin, a preservative or fungicide, a pH adjuster, and other additives. These additives can be selected from among the materials cited in the above-described sections “1.3. Other Constituents” and “2.1.2. Other Constituents”.

### 2.3. Properties of Inks

Preferably, the absolute value (|S1−S2|) of the difference between S1 and S2 is 5 or less, more preferably 1.5 or less. When the difference between S1 and S2 is 5 or less, the weighted average S3 of the SP values of the organic solvents and water in the cleaning solution and the SP value of the organic solvent in the cleaning solution come close to both S1 and S2. Accordingly, the compatibility of the cleaning solution with the non-aqueous ink and the aqueous ink is enhanced, and the cleaning power of the cleaning solution thus can be further enhanced.

Preferably, the range between S1 and S2 is from 10.0 to 15.0, more preferably from 11.5 to 13.0. When the range between S1 and S2 is such a range, S3 and the SP value of the organic solvent in the cleaning solution come close to both S1 and S2. Accordingly, the compatibility of the cleaning solution with the non-aqueous ink and the aqueous ink is enhanced, and the cleaning power of the cleaning solution thus can be further enhanced.

Preferably, the non-aqueous ink and the aqueous ink each have a surface tension at 20° C. in the range of 20 to 50 mN/m, more preferably in the range of 20 to 40 mN/m, from the viewpoint of the balance between the resulting image quality and the reliability of the ink jet ink. The surface tension can be obtained by measuring an ink wetting a platinum plate at 20° C. with, for example, an automatic surface tensiometer CBVP-Z (manufactured by Kyowa Interface Science).

Also, the non-aqueous ink and the aqueous ink preferably have a viscosity in the range of 2 to 10 mPa·s, more preferably 3 to 6 mPa·s, at 20° C. from the same viewpoint as above. The viscosities of the inks can be measured at 20° C. using a viscoelasticity meter MCR-300 (manufactured by Pysica).

### 2.4. Preparation of Inks

The non-aqueous ink and the aqueous ink can be prepared by mixing the above-described constituents in an arbitrary order and optionally removing impurities by, for example, filtration. It may be suitable for mixing that the constituents are added one after another into a container equipped with a stirrer, such as a mechanical stirrer or a magnetic stirrer, and mixed together. Filtration may be performed as required by, for example, centrifugal filtration or using a filter paper.

### 3. INK JET RECORDING APPARATUS

The cleaning solution of the present embodiment is used in an ink jet recording apparatus including an ink flow channel through which at least a non-aqueous ink or an aqueous ink flows, for washing off the ink or foreign matter present in the ink flow channel. An ink jet recording apparatus in which the cleaning solution can be used will be described below.

In the ink jet recording apparatus, both a non-aqueous ink and an aqueous ink may be used. The ink jet recording apparatus may contain both the non-aqueous ink and the aqueous ink so as to be used simultaneously, or may include a selector for switching the non-aqueous ink and the aqueous ink.

In the following description, an ink jet recording apparatus including a selector for switching the non-aqueous ink and the aqueous ink is illustrated by way of example. However, the above-described cleaning solution can be used in known ink jet recording apparatuses as well as the ink jet recording apparatus described below.

The figure is a schematic perspective view showing major parts of a printer 20 including a selector 56 that can switch a non-aqueous ink and an aqueous ink.

As shown in the figure, the printer 20 may include a paper stacker 22, a paper feed roller 24 driven by a stepping motor (not shown), a platen 26, a carriage 28, a carriage motor 30, a pulling belt 32 driven by the carriage motor 30, and guide rails 34 that guide the scanning operation of the carriage 28. The carriage 28 is provided with a recording head 36 including a plurality of nozzles thereon.

As shown in the figure, liquid supply channels 41 to 44 connect the nozzles (not shown) of the recording head 36 with the selector 56. The recording head 36 is connected to cartridges 11a and 11b through the liquid supply channel 41, to cartridges 12a and 12b through the liquid supply channel 42, to cartridges 13a and 13b through the liquid supply channel 43, and to cartridges 14a and 14b through the liquid supply channel 44. Also, a cartridge 15 is connected to each of the liquid supply channels 41 to 44.

As shown in the figure, cartridge 11a contains a black ink (K1); cartridge 11b contains a black ink (K2); cartridge 12a contains a cyan ink (C1); cartridge 12b contains a cyan ink (C2); cartridge 13a contains a magenta ink (M1); cartridge 13b contains a magenta ink (M2); cartridge 14a contains a yellow ink (Y1); and cartridge 14b contains a yellow ink (Y2). Inks K1, C1, M1 and Y1 are non-aqueous inks, and inks K2, C2, M2 and Y2 are aqueous inks. Cartridge 15 contains a cleaning solution.

Inks of the same color are ejected through the same nozzle. For example, black ink K1 is ejected through one of the nozzles of the recording head 36, through which black ink K2 is ejected. The same applies to the other inks.

The non-aqueous ink, the aqueous ink and the cleaning solution are selectively supplied to the liquid supply channels 41 to 44 through the selector 56. When the non-aqueous ink and the aqueous ink of each set are switched from one to the other, the cleaning solution is delivered to the liquid flow channels 41 to 44 to wash the liquid flow channels and the ink flow channels in the recording head through which the inks flow.

Each cartridge includes an ink pack containing an ink and an air chamber around the ink pack. On applying a pressure to the air chamber with a pressurizing device (not shown), the ink in the ink pack is delivered to the corresponding nozzle of the recording head 36 through the corresponding one of the liquid supply channels 41 to 44. Unlike an on-carriage type printer in which ink cartridges are mounted on a carriage, the printer 20 used in the present embodiment is an ink jet printer of an off-carriage type in which the ink cartridges are fixed to a predetermined position of the printer 20. Although, in the present embodiment, the ink is ejected through a nozzle by applying a pressure with a pressurizing device, the ink may be ejected (extracted) through the nozzle by suction. The cleaning solution may be used in an on-carriage type printer. Also, the cleaning solution may be used in a line head printer not including a carriage.

As shown in the figure, one side of the selector 56 is connected to the cartridges 11a, 11b, 12a, 12b, 13a, 13b, 14a, 14b and 15. The other side is connected to the liquid supply channels 41, 42, 43 and 44. The selector 56 may include valves that switch the liquid flow going to the liquid supply channels 41 to 44 among the non-aqueous inks, the aqueous inks and the cleaning solution. One of the non-aqueous inks, aqueous inks and cleaning solution is selected by the switching operation of any of the valves, and the selected liquid is delivered to the corresponding one of the liquid supply channels 41 to 44.

Recording paper P (recording medium) is rolled round the paper feed roller 24 from the paper stacker 22, and transported on the surface of the platen 26 in a sub-scanning direction perpendicular to a main scanning direction of the recording head 36. The carriage 28 is drafted by the pulling belt 32 driven by the carriage motor 30, thereby moving in the main scanning direction along the guide rails 34.

The above-described cleaning solution can be used in common for an ink jet recording apparatus using one of a non-aqueous ink and an aqueous ink and for a recording apparatus using the other ink, or can be used in a recording apparatus, such as the printer 20, using both inks at one time or with switching, without requiring two cleaning solutions, one for each ink. Therefore, operation for switching cleaning solutions, which has been required in the known art, can be omitted, or a mistake in selecting a cleaning solution can be prevented.

### 4. CLEANING METHOD

A cleaning method using the above-described cleaning solution will be described in detail below. The cleaning method is applied to an ink jet recording apparatus, such as the printer 20, including an ink flow channel through which at least either a non-aqueous ink or an aqueous ink flows, and the ink flow channel is cleaned with the cleaning solution.

More specifically, the cleaning of the ink flow channel is performed by introducing the cleaning solution into the ink flow channel filled with a non-aqueous ink or an aqueous ink so as to replace the ink with the cleaning solution. Thus, foreign matter in the ink flow channel and the ink are discharged together through a nozzle aperture, so that the ink flow channel is cleaned.

The ink flow channel thus washed with the cleaning solution may be kept filled with the cleaning solution if the ink jet recording apparatus will not be used for recording for a long time. This can prevent contamination with foreign matter derived from an ink.

For recording an image with an ink jet recording apparatus, an ink is introduced to the ink flow channel filled with the cleaning solution to discharge the cleaning solution through the nozzle aperture and fill the ink flow channel again.

Since the above-described cleaning solution is used in the cleaning method of the present embodiment, both a non-aqueous ink and an aqueous ink can be washed off satisfactorily.

### 5. EXAMPLES

The invention will be further described with reference to specific Examples and Comparative Examples. However, it is not limited to the Examples.

### 5.1. Preparation of Inks and Cleaning Solution

### 5.1.1. Preparation of Non-Aqueous Ink

Organic solvents were placed in a vessel according to the composition shown in Table 1, and stirred with a magnetic stirrer for 30 minutes to yield a mixed solvent. Predetermined amounts of Solsperse 37500 (produced by LUBRIZOL) and a pigment were added to an aliquot of the mixed solution and pulverized with a homogenizer. Then, the sample was subjected to dispersion in a bead mill charged with zirconia beads of 0.3 mm in diameter, thus preparing a pigment dispersion. The rest of the mixed solvent was added to the resulting pigment dispersion, followed by stirring for one hour. Then, the mixture was filtered through a 5 μm PTFE membrane filter to yield the non-aqueous ink shown in Table 1. The values in Table 1 are represented in percent by mass.

Constituents designated by a trade name or an abbreviation in Table 1 are as follows:
C. I. Pigment Black 7 (black pigment “MA-7” produced by Mitsubishi Chemical)
Solsperse 37500 (dispersant, produced by LUBRIZOL)
DEGDEE (diethylene glycol diethyl ether, organic solvent)
DEGMEE (diethylene glycol methyl ethyl ether, organic solvent)

TABLE 1

| Constituent | | SP value | Non-aqueous ink |
|---|---|---|---|
| Pigment | Pigment Black 7 | — | 4 |
| Dispersant | Solsperse 37500 | — | 4 |
| Organic solvent | DEGDEE | 9.5 | 72 |
| | DEGMEE | 9.6 | 10 |
| | γ-butyrolactone | 14.8 | 10 |

| | |
|---|---|
| Total (mass %) | 100 |
| Weighted average SP value S1 | 10.1 |

### 5.1.2. Preparation of Aqueous Ink

Ion exchanged water and Disper BYK-2091 and Disper BYK-2095 (each produced by BYK) were placed in a vessel and mixed with a magnetic stirrer for 30 minutes. Then, a predetermined amount of a pigment was added to the mixture and dispersed in a bead mill charged with zirconia beads of 0.6 mm in diameter for 3 hours. Thus, a pigment dispersion containing 15% of pigment was obtained. The rest of the constituents shown in Table 2 were added to the pigment dispersion, followed by stirring for one hour. Then, the mixture was filtered through a 5 μm PTFE membrane filter to yield the aqueous ink shown in Table 2. The values in Table 2 are represented in percent by mass.

Constituents designated by a trade name or an abbreviation in Table 2 are as follows:
C. I. Pigment Black 7 (black pigment “MA-7” produced by Mitsubishi Chemical)
Disper BYK-2091 (dispersant, produced by BYK)
Disper BYK-2095 (dispersant, produced by BYK)
TEA (triethanolamine, pH adjuster)
TEGmBE (triethylene glycol monobutyl ether, organic solvent)
TEG (triethylene glycol, organic solvent)

TABLE 2

| Constituent | | SP value | Non-aqueous ink |
|---|---|---|---|
| Pigment | Pigment Black 7 | — | 4 |
| Dispersant | Disper BYK-2091 | — | 3 |
| | Disper BYK-2095 | — | 1 |
| pH adjuster | TEA | — | 0.8 |
| Organic solvent | TEGmBE | 11 | 10 |
| | TEG | 13.8 | 10 |
| | glycerol | 17.2 | 20 |
| Water | Ion exchanged water | 23.3 | 51.2 |

| | |
|---|---|
| Total (mass %) | 100 |
| Weighted average SP value S2 | 14.8 |

### 5.1.3. Preparation of Cleaning Solution

According to the composition shown in Table 3, constituents were mixed by stirring, and the mixture was filtered through a 5 μm PTFE membrane filter. Thus, cleaning solutions of Examples and Comparative Examples shown in Table 3 were prepared. The values in Table 3 are represented in percent by mass.

Constituents designated by a trade name or an abbreviation in Table 3 are as follows:
TEGmBE (triethylene glycol monobutyl ether, organic solvent)
DMSO (dimethyl sulfoxide, organic solvent)
TEGDME (triethylene glycol dimethyl ether, organic solvent)

TABLE 3

| | | | | | | Comparative | Comparative | Comparative | Comparative | Comparative |
|---|---|---|---|---|---|---|---|---|---|---|
| Constituent | | SP value | Example 1 | Example 2 | Example 3 | Example 1 | Example 2 | Example 3 | Example 4 | Example 5 |
| Organic | DEGDEE | 9.5 | | | | | 20 | | | |
| solvent | TEGmBE | 11.0 | | 30 | | 20 | 20 | 20 | | |
| | 1,2-Hexanediol | 11.5 | 40 | 30 | | 30 | 20 | 30 | 30 | 50 |
| | DMSO | 12.6 | 40 | | 80 | | | | | 50 |
| | γ-butyrolactone | 14.8 | | 20 | | 20 | 20 | 20 | 10 | |
| | TEGDME | 16.4 | | | | | | 20 | 20 | |
| Water | Ion exchanged | 23.3 | 20 | 20 | 20 | 30 | 20 | 10 | 40 | |
| | water | | | | | | | | | |
| Total (mass %) | | | 100 | 100 | 100 | 100 | 100 | 100 | 100 | 100 |
| Weighted average SP values S3 | | | 14.3 | 14.4 | 14.7 | 15.6 | 14.0 | 14.2 | 17.5 | 12.1 |
| Evaluation | Cleaning power | Non-aqueous | 18 | 24 | 24 | 40 | 30 | 36 | 46 | 18 |
| | | ink | | | | | | | | |
| | | Aqueous ink | 12 | 18 | 24 | 30 | 30 | 24 | 24 | 60 |
| | Foreign matter | Non-aqueous | None | None | None | None | None | Occurred | Occurred | None |
| | | ink | | | | | | | | |
| | | Aqueous ink | None | None | None | Occurred | Occurred | None | None | Occurred |

### 5.2. Evaluation

### 5.2.1. Cleaning Power

### Cleaning Power Against Non-Aqueous Ink

A polyethylene tube (manufactured by Hokko Kasei, 2 mm in inner diameter, 4 mm in outer diameter) of 2 m in length was prepared. One end of the polyethylene tube was connected to a plastic syringe (manufactured by Terumo Corporation) through a Tygon tube R3603 (manufactured by Saint-Gobain). The polyethylene tube was then filled with the non-aqueous ink by sucking the ink into the tube from the other end of the tube, using the syringe, and subsequently the non-aqueous ink was extracted from the polyethylene tube.

Then, the cleaning solution was passed through the polyethylene tube, using the syringe, and aliquots of 6 mL each were taken one after another from the cleaning solution that had been passed through the polyethylene tube. The aliquots were visually observed one after another until the aliquot observed became transparent, and the total volume of the observed aliquots was recorded. The cleaning power of the cleaning solution against the non-aqueous ink was evaluated by the recorded total volume of the cleaning solution. Evaluation results are shown in Table 3.

Cleaning Power against Aqueous Ink

The cleaning power against the aqueous ink was evaluated in the same manner as that against the non-aqueous ink, except that the non-aqueous ink was replaced with the aqueous ink. Evaluation results are shown in Table 3.

5.2.2. Contamination with Foreign Matter
Foreign Matter Derived from Non-Aqueous Ink

A mixture containing the non-aqueous ink and the cleaning solution in a proportion of 1:1 was prepared, and the mixture was allowed to stand at 60° C. for one week. Then, the mixture was filtered through a 10 μm Omnipore membrane filter (manufactured by millipore), and the membrane filter was observed through a microscope at a magnification of 50 times to evaluate whether or not contamination with foreign matter had occurred. Evaluation results are shown in Table 3.

Foreign Matter Derived from Aqueous Ink

Evaluation of whether or not contamination with foreign matter has occurred was performed in the same manner as described in the section “Foreign Matter Derived from Non-aqueous Ink”, except that the non-aqueous ink was replaced with the aqueous ink. Evaluation results are shown in Table 3.

### 5.2.3. Evaluation Results

The results shown in Table 3 suggest that the cleaning solutions of Examples 1 to 3, in which the organic solvent had an SP value in the range between S1 and S2 and the S3 value was in the range between S1 and S2, can wash off both the non-aqueous ink and the aqueous ink satisfactorily without contamination with foreign matter.

On the other hand, the cleaning solution of Comparative Example 1, which had a S3 value outside the range between S1 and S2, did not satisfactorily wash off either the non-aqueous ink or the aqueous ink, and foreign matter derived from the aqueous ink occurred.

The cleaning solution of Comparative Example 2, which contained an organic solvent having an SP value outside the range between S1 and S2, did not satisfactorily wash off the non-aqueous ink or the aqueous ink, and foreign matter derived from the aqueous ink occurred.

The cleaning solution of Comparative Example 3, which contained an organic solvent having an SP value outside the range between S1 and S2, did not satisfactorily wash off particularly the non-aqueous ink, and foreign matter derived from the non-aqueous ink occurred.

The cleaning solution of Comparative Example 4, which contained an organic solvent having an SP value outside the range between S1 and S2 and had an S3 value outside the range between S1 and S3, did not satisfactorily wash off particularly the non-aqueous ink, and foreign matter derived from the non-aqueous ink occurred.

The cleaning solution of Comparative Example 5, which did not contain water, did not satisfactorily wash off the aqueous ink, and foreign matter derived from the aqueous ink occurred.

The invention is not limited to the above-described embodiments, and various modifications may be made. For example, the invention includes substantially the same form as the disclosed embodiments (for example, a form including the same function and method and producing the same result, or a form having the same intent and producing the same effect). Some elements unessential to the form of the disclosed embodiment may be replaced. The form of an embodiment of the invention includes an element producing the same effect or achieving the same object, as the form of the disclosed embodiments. The forms of the disclosed embodiments may be combined with the known art.

The entire disclosure of Japanese Patent Application No.: 2012-228638,filed Oct. 16, 2012 is expressly incorporated by reference herein.

What is claimed is:

1. An ink jet cleaning solution for washing off a non-aqueous ink and an aqueous ink, each containing at least one organic solvent, the ink jet cleaning solution comprising:
water; and
an organic solvent having a solubility parameter in the range between the weighted average solubility parameter S1 of the organic solvent contained in the non-aqueous ink and the weighted average solubility parameter S2 of the organic solvent contained in the aqueous ink,
wherein the weighted average of the solubility parameters of the organic solvent and water in the cleaning solution is in the range between the weighted average solubility parameters S1 and S2.

2. The cleaning solution according to claim 1, wherein the organic solvents in the cleaning solution, the non-aqueous ink and the aqueous ink each contain a water-soluble organic solvent.

3. The cleaning solution according to claim 1, wherein the organic solvent in the cleaning solution has a hydroxy group.

4. The cleaning solution according to claim 1, wherein the difference between S1 and S2 is 5 or less.

5. The cleaning solution according to claim 1, wherein the range between S1 and S2 is from 10.0 to 15.0.

6. The cleaning solution according to claim 1, wherein the range between S1 and S2 is from 11.5 to 13.0.

7. The cleaning solution according to claim 1, wherein the cleaning solution is used in an ink jet recording apparatus using both the non-aqueous ink and the aqueous ink.

8. The cleaning solution according to claim 1, wherein the organic solvent in the cleaning solution contains at least one compound selected from the group consisting of polyhydric alcohols and glycol ethers.
